(19) United States
(12) Patent Application Publication
(10) Pub. No.: US 2025/0077335 A1
(43) Pub. Date: Mar. 6, 2025

(54) APPLICATION LANDSCAPE PATTERN DETECTION

(71) Applicant: SAP SE, Walldorf (DE)

(72) Inventors: Premchand Nutakki, Wiesloch (DE); Jochen Steinmetz, Neckargemuend (DE); Yannick Ulmrich, Leimen (DE); Volker Driesen, Heidelberg (DE)

(21) Appl. No.: 18/242,103

(22) Filed: Sep. 5, 2023

(51) Int. Cl. G06F 11/07; G06F 11/30

(52) U.S. Cl. CPC G06F 11/0793; G06F 11/3006; G06F 11/3072

(57) ABSTRACT

Methods, systems, and computer-readable storage media for are directed to techniques and tools for analyzing data collected at application landscapes to detect patterns in configurations of tenants, services, and integrations between tenants and services. Snapshot data representing configurations defined for customers of a solution environment can be ready. The solution environment comprises a set of landscapes. The snapshot data includes data for integrations between tenants and/or services of a set of customers. The snapshot data can be evaluated according to detection algorithms to identify patterns in configurations in the solution environment based on historized snapshot data stored over time. A first identified pattern of the patterns associated with a first configuration of the configurations in the solution environment is classified as one of an anomaly configuration type or a standard configuration type. The classifying is based on using tracked data for historically classified patterns associated with the solution environment.

### TECHNICAL FIELD

The present disclosure relates to computer-implemented methods, software, and systems for data processing.

### BACKGROUND

Customers' needs are transforming and imposing higher requirements for process execution, lifecycle management, and technical landscape that also support high availability to access software resources provided by an underlying software platform.

Software applications, systems, services, and devices, among other examples, can be associated with configurations and/or process integrations that relate to their performance.

### SUMMARY

Implementations of the present disclosure are directed to techniques and tools for analyzing data collected at application landscapes to detect patterns in configurations of tenants, services, and integrations between tenants and services. More particularly, implementations of the present disclosure are directed to tracking anomalies or errors as patterns that can be observed at a solution landscape and once detected, can be used to execute remedy actions to eliminate such anomalies for the landscapes.

In some implementations, a method includes reading snapshot data representing configurations defined for customers of a solution environment, wherein the solution environment comprises a set of landscapes, wherein the snapshot data includes data for integrations between tenants and/or services of a set of customers; evaluating the snapshot data according to detection algorithms to identify patterns in configurations in the solution environment based on historized snapshot data stored over time; and classifying a first identified pattern of the patterns associated with a first configuration of the configurations in the solution environment as one of an anomaly configuration type or a standard configuration type, wherein the classifying is based on using tracked data for historically classified patterns associated with the solution environment.

Other implementations of this aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2A depicts example customer landscape directory (CLD) 200 where CLD data 204 is collected from a solution environment 203 comprising multiple computer landscapes where tenants and services are configured to integrate and provide resources to customers.

FIG. 2B depicts an example system for collecting and processing configuration data obtained from a solution environment to evaluated detected patterns in accordance with implementations of the present disclosure.

FIG. 3 depicts an example process that can be executed in accordance with implementations of the present disclosure.

FIG. 4 is a schematic illustration of example computer systems that can be used to execute implementations of the present disclosure.

### DETAILED DESCRIPTION

Implementations of the present disclosure are directed to techniques and tools for analyzing data collected at application landscapes to detect patterns in configurations of tenants, services, and integrations between tenants and services. More particularly, implementations of the present disclosure are directed to tracking anomalies or errors as patterns that can be observed at a solution landscape and once detected, can be used to execute remedy actions to eliminate such anomalies for the landscapes.

Solution environment can include software systems and/or applications or services that can be integrated to execute processes and serve user requests. In some instances, a single customer may use multiple services and/or multiple tenants defined at the solution environment. For example, a customer can use shared services such as identity and access management, document rendering, or printing, among other example services, and can have tenants for various applications or systems such as an enterprise resource planning (ERP) application, a finance or logistics solutions.

When a customer wants to use a solution product (e.g., service, system application, or combination thereof), a set of tenants and accounts for services can be created and assigned to the customer. In some instances, tenants can be defined for a solution such as a cloud platform solution, a business application solution, or other composition of applications and services. In some instances, accounts can be defined for respective customers having access to one or more services. In some implementations, integrations can be configured between tenants, so a tenant can request a resource from a service instance automatically, without having to login on each tenant and service. In some instances, tenants defined for customers can be integrated and can form an “application landscape”.

In some implementations, a solution environment (e.g., an environment including a single or multiple landscapes at respective data center(s)) can be provisioned through an automated service, with a programmed sequence of creating such tenants and configuring integrations between tenants and for various services and/or applications running on the application landscape. In some instances, versions of configurations and integrations between services can be programmed over time and those configurations and integrations can vary for different tenants. In some instances, an application landscape including services accessible by multiple customers can become heterogeneous and, in some cases, inconsistent or incorrect.

In some cases, an application solution can be offered as a service, where the solution can include “default” components, which may be available to all customers that have access to the application solution. However, in some cases, some of the customers can also have “optional” components, which are only used in a certain configuration and not all customers have such optional components deployed in the solution environment. Additionally, different customers can be configured to work with the solution at a different point in time, hence one customer may use a different solution version compared to another, and thus, at least two customers may have different configurations. Such differences in the configurations, combinations and integrations can define a variety of landscapes relevant for various customer.

In some implementations, during provisioning of services relevant for a particular customer (with one or more tenants), there can be errors in the deployment, whereby some or all of the tenants may be removed or partially decommissioned by accident. In some cases, such issues can be caused by system failures that can be experienced at a data center where the solution is running. Disasters like a data center failure can also result in a corrupted set of tenants being available since not all tenants may have been configured properly with a disaster recovery setup (e.g., the disaster recovery setup may be used inconsistently or incorrectly). Thus, in some cases there are chances for errors during deployment of solutions as provided by the same vendor (or provider) as the solution provider, from a third-party provider, or from self-built extension services that can be added to the solution in customized way.

In some implementations, solution landscapes that are provided as services to various customers, where different customers are associated with different configurations and integrations for the included applications and services in the solution landscape, can be associated with higher risk of inconsistencies and errors, higher maintenance fees for covering multiple setups and versions, increased complexity for the landscape management, or inefficiencies in the setups and processing, among other example corruptions in the landscape.

In some implementations, configurations on a solution landscape can be evaluated and some of the configurations can be determined as “standard”, which can refer to combination of services and respective configurations and integrations that are common for multiple customers of the landscape. In some cases, a configuration that is common to multiple customers can be evaluated to determine whether it meets a criterion for a “standard configuration.” For example, data for the configuration can be evaluated based on a threshold number of customers using the configuration, the number of services involved in the configuration, and/or with references to the number of other configurations for similar set of services. In some cases, a “standard configuration” can be evaluated whether it meets criteria of the solution vendor or provider, and in those cases, the configuration can be considered as a “gold standard.” Deviations of other customer configurations to the “gold standard” can be determined so that those cases are evaluated and determined whether they are to be migrated towards a “gold standard” might be planned.

In some implementations, tracking of configurations defined for customers of a service solution environment can be performed to determine a default set of components (e.g., number of tenants, services, and integrations between tenants and services) and determine optional components in configurations. For example, based on tracking of configurations (e.g., based on historical data), it can be determined that a configuration including five (5) tenants and one service can include 4 default components that can be four (4) of the tenants, and the last tenant and service can be optional. In this example, if the four default components form a default set of components, then it can be determined that this is a standard configuration. In some cases, a configuration that includes a default set of components and an optional component can be configured as a standard configuration and can be classified as such. In some cases, based on an evaluation of configurations of customers, new standard configurations can be defined, where new standard configuration can be based on considerations for unifying the number of components and integrations between them in a homogeneous way in the solution environment thus to support improved performance, reduced costs for maintenance, lower the chance for failure and errors that can disrupt product processes, and process executions, among other examples.

In some instances, snapshot data can be collected from a landscape and can be provided to a pattern detection service that can analyze the data and detect patterns in configurations on the landscape that can be classified as of different types, such as an anomaly classification type, or a standard classification type. In some instances, the pattern detection service can implement algorithms to evaluate obtained snapshot data and to user historized data snapshots to evaluate the configurations of customer and classify identified patterns in the configurations in accordance with the implementations of the present disclosure.

In some cases, a customer can have a configuration that can deviate from a standard configuration. In some cases, an administrator or a service can analyze the configuration and determined whether that can be classified as an “intended configuration” (because missing components are “optional” and additional components are “extensions”, e.g., can be classified as a custom one). In other cases, it can be determined that it is an erroneous configuration, which needs to be corrected, as it can lead to application failure or failure during the upgrade to a new solution version.

In some cases, a new configuration can be defined for a customer at a solution environment, where the new configuration can be limited and, upon evaluation, the new configuration can be considered as an isolated case and even an anomaly. However, a pattern detection algorithm can evaluate the data and provide such identified configuration for further evaluation and consideration for a finalized status that if determined to be a standard configuration type instead of an anomaly configuration type can be included in rules implemented to evaluated detected patterns.

In some instances, customers can run a landscape as part of a solution environment to test processes and process configurations (e.g., business customizing, key user extensions, customer's own developments and extensions). Such testing can be performed before configuring the processes in the same way in a production landscape. Typically, a test and production landscape use disjoint tenants and services. Keeping a production landscape apart from a testing landscape can support data isolation and reducing the risk of erroneous data modification, as well as possible setup modification(s) that can lead to additional errors.

In some instances, if an anomaly is found in the configuration data for a customer, such configuration data can be used to identify a landscape of the customer associated with the anomaly and a change to the landscape can be executed so that subsequent data evaluation can yet evaluation results that do not identify anomalies as patterns in the data.

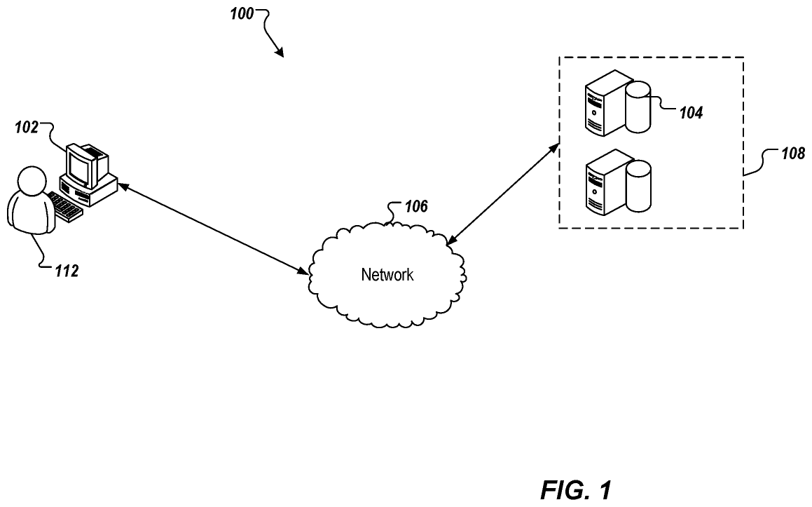

FIG. 1 depicts an example architecture 100 in accordance with implementations of the present disclosure. In the depicted example, the example architecture 100 includes a client device 102, a network 106, and a server system 108. The server system 108 includes one or more server devices and databases 104 (e.g., processors, memory). In the depicted example, a user 112 interacts with the client device 102.

In some examples, the client device 102 can communicate with the server system 108 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 108 includes at least one server and at least one data store. In the example of FIG. 1, the server system 108 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 108 can host a solution environment that can be a cloud environment providing software applications, systems, and services that can be consumed by customers as a service. In some instances, the server system 108 can support configuring of various tenants of different type, as well as services of different type that are integrated in customer integration scenarios and support execution of defined processes.

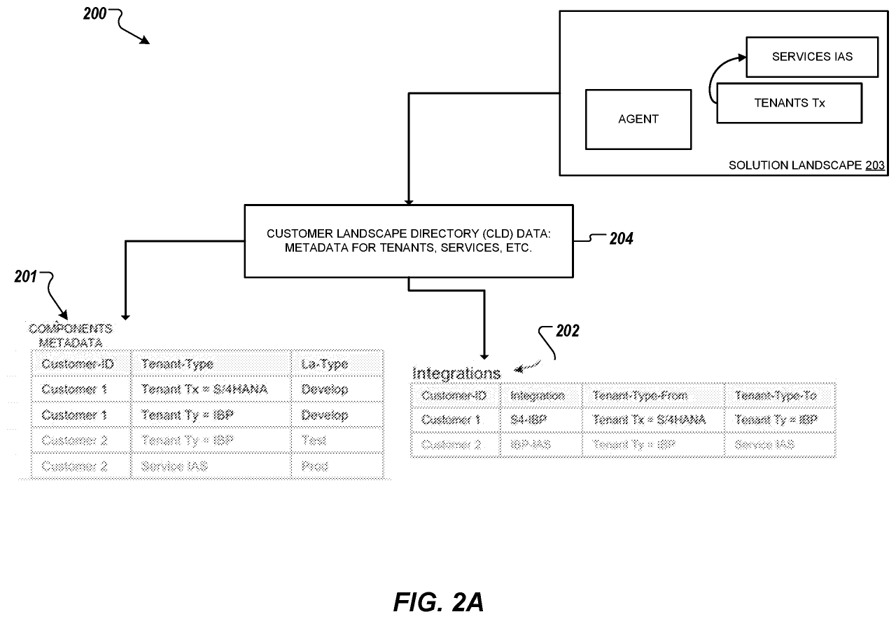

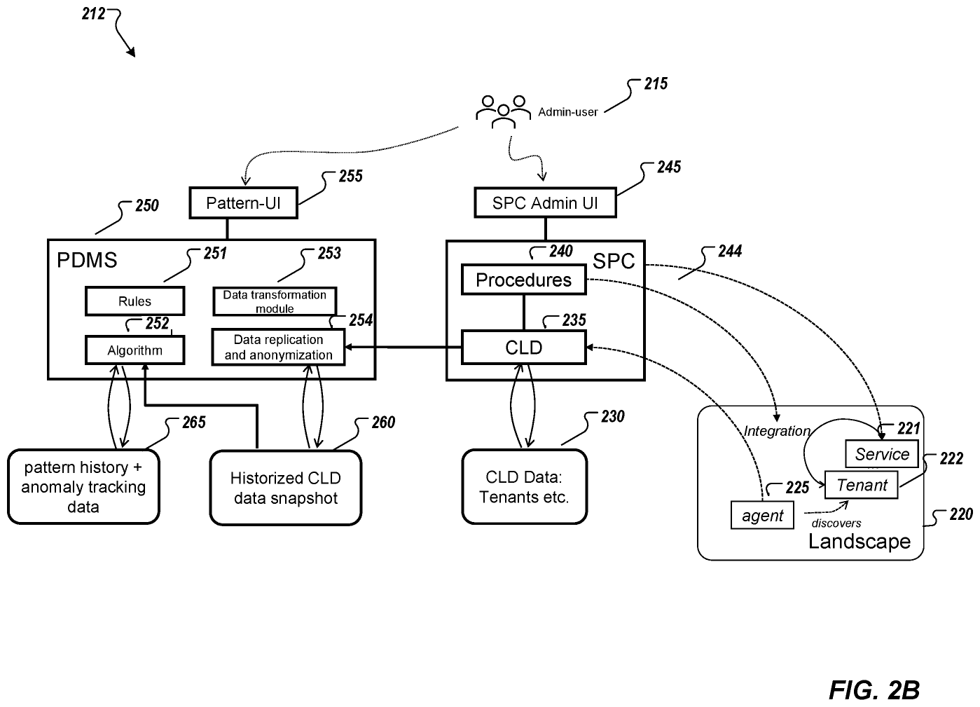

FIG. 2A depicts example customer landscape directory (CLD) 200 where CLD data 204 is collected from a solution environment 203 comprising multiple computer landscapes where tenants and services are configured to integrate and provide resources to customers. In some instances, a solution environment 203 can be provided where tenants and/or services of various types are running and are integrated to provide services to customers. The tenants are instances of different tenant types (Tx) and the services are instances of different service types, such as an identity authentication service type. The solution landscape can have configured agents that can collect data about the execution of tenants and services and provide the data to the CLD 200 to be stored. Data for the different customers is stored in the CLD data 204 to reflect data about components (or instances) 201 running on the landscape as well as the integrations 202.

The CLD data 204 can be stored as part of a cockpit that monitors the configurations at the solution environment 203 in the CLD 200 environment or at a separate external storage. The CLD data 204 can include data record identifying a mapping between a customer identifier, a tenant instance type associated with the customer identifier, and optionally can define a landscape type where the instance is running, such as where there are multiple landscape types (e.g., production and testing). In the example components data 201 for tenants and services there are four records associated with two customers that have running components of different type (i.e., S/4HANA and IAS) or of same type (i.e., Ty=IBP) that run at various landscapes (e.g., development, production, testing). The integrations data 202 provides information for integration between tenants and/or services per each customer. In the example, the first customer has an integration between two tenant instances of different tenant type, and the second customer has a defined integration between a tenant and a service. These are example integrations, and various combination of integrations can be defined between different sets of tenants and/or services.

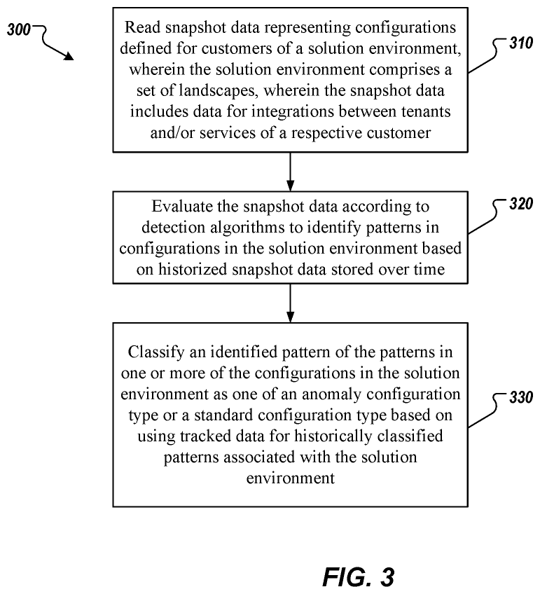

In the example integrations of FIG. 2A, the second customer has an integration IBP-IAS. It is noted that the integration can be uniquely identified based on name, identifier, or other convention or factor. The tenant and the service are instances running at different landscapes; here, at a test landscape and a production landscape. In some cases, such a configuration that integrates components running at different landscapes can be assessed as erroneous and thus classified as an anomaly. This classification can be used to raise a notification for further evaluation and the identified anomaly can be used as the basis for generation of an execution plan to remedy the anomaly. The evaluation and the classification of the CLD data 240 stored by the CLD 200 can be done in substantially similar way as described throughout the present disclosure and for example, at FIG. 3.

FIG. 2B depicts an example system environment 212 for collecting and processing configuration data obtained from a solution environment to evaluated detected patterns in accordance with implementations of the present disclosure.

The example system environment 212 comprises a solution landscape 220 that can be substantially similar to or different from the solution landscape 203 of FIG. 2A. The solution landscape 220 can be one of multiple landscape defined in a solution environment where services 221 and tenants 222 are running and are integrated. The solution landscape can include services 221, tenants 220, and agents 225 running at the solution landscape 220 that can collect snapshots of the configurations associated with different customers and provide such data to a service provider cockpit (SPC) 244. The SPC 244 can be configured to include procedures 240 that can be used to configure the integrations at the landscape 220. An agent 225 can be also installed at the landscape 220 that can be configured to collect snapshot data for different configurations of services and tenants at the landscape and can provide such collected snapshot data to the SPC 244 through the Customer Landscape Directory component 235 that can obtain snapshot data periodically from the landscape 220 and store it at the CLD data 230. In some instances, the CLD data 230 can be stored in substantially similar manner and structure as described for the CLD data 204 at the CLD 200 of FIG. 2A.

In some instances, the SPC 244 can be configured to provide snapshot data to a data replication and anonymization component 254 of a pattern detection and management service (PDMS) 250. The data replication and anonymization component 254 can anonymize the obtained snapshot data from the CLD 235 of the cockpit 244 and can store such anonymized data as historical customer landscape data 260. In some instances, the CLD 235 can provide the data to the PDMS 250 based on a configured or predefined schedule, periodically, or upon request for execution of an evaluation of the status of the landscape 220, among other example event to trigger data evaluation. Once the data is anonymized, the data is provided to a data transformation module 253 that can be used to adjust the read snapshots from the CLD 235. The anonymized data is transformed and then the transformed data is stored and/or presented for preview at a UI, such as the pattern-UI 255 that can be accessible by an administrator or an operator of the PDMS 250, the SPC 244, and/or the landscape 220.

The transformed and anonymized data can be provided for execution of pattern recognition based on algorithms 252. A set of pattern detection algorithms can be applied to the data, and identified patterns can be presented on the Pattern-UI 255 to an admin-user 215 or another user that can process or navigate the data for further processing. The algorithm 252 module includes detection algorithms for identifying patters in the snapshots of configurations in the landscape 220. When a pattern is identified, the pattern can be annotated based on a respective pattern determination algorithm from the algorithms 252 that was used. The pattern can also be annotated in multiple optional ways, including with regard to the customer that is associated with the configuration that includes the pattern, the tenant/service identifier(s) associated with the configuration, and additional attributes or information such as unique names, timestamps, or suitable information. Identified patterns by the algorithm 252 component can be stored as annotated in the pattern history 265, which can then be used to track anomalies in the configuration in accordance with implementations of the present disclosure. In some instances, the algorithm 252 can be used to execute the evaluation and classification of identified patterns as described in relation to FIG. 3.

In some instances, a pattern can be identified and annotated according to one of the following categories that provide assessment for the configuration associated with the patters:
“identified error—to-be-observed” or “anomaly-to-be-observed”,
“gold standard—to-be-observed”,
“minor—stop-observation”, “no anomaly-stop-observation”.

In some instances, annotations to patterns can also be provided as free text by the admin-user 215. In some instances, the pattern detection can be executed over updated sets of snapshot data over the same landscape once an execution of a remedy action was performed to recover from an identified anomaly. In some instances, a new result for a found new pattern can be related to a previously observed and stored pattern. Based on identification of patterns, new patterns can be added in the pattern history 265 which can be used to more quickly classify patterns identified in other configurations. In some instances, patterns identified in two subsequent runs of pattern detection algorithms can be provided for comparison to support evaluation of the status of the landscape and to classify identified patterns. The patterns can be classified according to a classification scale, for example, include a set of classification types.

In some instances, once a pattern is identified, the pattern can be provided to the pattern-UI 255. An admin-user 215 can specify rules they want to run on the data to identify problematic situations with identified patterns. Thus, detected patterns at the algorithm 252 can be used as a candidate set of patterns that can be evaluated based on the rules 251 to determine status of the landscape and the configurations defined. In some instances, a rule framework with a rule-editor for admins can be added to the PDMS 250 and integrated with the Pattern-UI 225. The PDMS 250 can execute scans on obtained latest snapshots of the landscape and apply defined rules 251.

In some instances, the rules 251 can be defined as data point combinations (e.g. “a tenant of type” at a landscape type “development” and a tenant of type at a landscape type “production” have an integration [of type “xxx”]). When a rule is found to match, a set of customer tenants may be involved and information for relevant customers can be presented on the UI 255 where admin-user 215 have access and can then further analyze the patterns.

In some instances, an admin-user 215 can trigger procedures to change the landscape 220. The changed landscape can be automatically reflected in the data representation of the application landscape with data snapshots that can be obtained.

In some instances, an admin-user 215 can trigger in the PDMS 250 a new run to capture a new snapshot including update transformation modules based on executions at the data transformation module 253 and the data replication and anonymization 254. The PDMS 250 can apply a set of pattern detection algorithms to the updated data. The PDMS 250 can then present a set of newly found/no longer found patterns to the admin-user 215. In some cases, a data engineer can assess the anomalies found.

In some instances, groups of customers having configurations matching a pattern can potentially be used in follow-up processes, e.g., a configuration is defined as “gold standard”, “anomaly,” or “critical”, among other examples, and upsell or remediation procedures can be triggered. If the snapshot data is annotated with the patterns, such data can be stored and used to assess the algorithm from a business perspective.

FIG. 3 depicts an example process 300 that can be executed in accordance with implementations of the present disclosure. In some instances, the process 300 can be executed at a pattern detection and management service (PDMS), such as the PDMS 250 of FIG. 2B. In some instances, the process 300 can obtain data such as the data 200 of FIG. 2A as snapshot data that can be used to evaluate configurations and determine patterns associated with the configurations that can be classified as anomalies or standard configuration types.

At 310, snapshot data representing configurations defined for customers of a solution environment is read. For example, the snapshot data can be data defining a configuration that includes data for tenants running for a given customer, services running for a given customer, and integrations for a given customer, among other information. In some instances, the snapshot data can include data such as the component data 201 and the integration data 202 of FIG. 2A. The snapshot data is data collected from a solution environment, where one or multiple landscapes can be defined. For example, the solution environment can include a test landscape, a development landscape, and a production landscape, where each landscape can be associated with a different development phase of a combination of services and tenants. For example, a customer may define a set of tenants and/or services to be provisioned at a test landscape, where a production landscape can include the same set. In some instances, some integrations defined in the production landscape can be different from the integrations in the test landscape, and the test landscape and/or the production landscape can have additional tenants and/or services. The tenants and services deployed for a given client are instances of a tenant type. Thus, multiple customers can have different instances of a same tenant type. For example, an ERP system can be defined as a tenant type, where two customers can have separate instances of the ERP system, where those instances can be associated with different configurations for different customers. In some instances, the received snapshot data at 310 includes data for integrations between tenants and/or services of a respective customer.

At 320, the snapshot data can be evaluated according to detection algorithms to identify patterns in configurations in the solution environment based on historized snapshot data stored over time.

In some instances, each configuration of the configurations is associated with a customer and defines at least one of i) a plurality of tenants of respective tenant types, a tenant of a tenant type and a service of a service type, or ii) a plurality of services of respective service types and an integration between tenants and/or services running on the solution environment.

In some instances, evaluating the snapshot data comprises executing the detection algorithms, such as the algorithms 252 of FIG. 2B. The identified patterns based on the algorithm's detection are provided to a user interface, such as the user interface Pattern-UI 255 of FIG. 2B, to obtain user input for evaluation of the identified pattern. The identified patterns and the assessment data generated based on the obtained user input as the tracked data used for the classifying of the identified pattern. In some instances, the assessment data comprises a classification type for each of the patterns, wherein the classification type comprises the anomaly configuration type and the standard configuration type.

At 330, a first identified pattern of the patterns associated with a first configuration of the configurations in the solution environment can be classified as one of an anomaly configuration type or a standard configuration type. The classifying is based classification patterns identified in historically tracked data associated with the solution environment. The tracked data can be such as the anomaly tracing data 265 of FIG. 2B.

In some instances, evaluating the snapshot data can identify that the first configuration matches a rule defined in a detection algorithm for anomalies. The matched rule can define an anomaly combination of tenants and/or services for an integration defined for a first client. The tenants and/or the services that are defined in the rule can be associated with different landscapes of the set of landscapes of the solution environment.

In some instances, the first identified pattern can be classified as the anomaly configuration type and the identified pattern can be provided for evaluation. In response to receiving input that the identified pattern is to be classified as a standard configuration type, the classification for the first identified pattern can be updated.

In some instances, data associated with the classified first pattern as of the anomaly configuration type can be provided to be used for evaluation and generation of instructions for executing a remediation procedure in the solution environment to modify configuration associated with the pattern to eliminate the anomaly.

In some cases, the first identified pattern can be classified as of the standard configuration type, when the first identified pattern meets a detection criterion defining a threshold number of customers associated with the same first identified pattern for each of respective configurations on the solution environment.

In some instances, the tracked data used for the classifying at 330 can be tracked data associated with the same customer as the customer associated with the identified pattern or with other customers that have a matching combination of tenants and/or services and their respective integration (e.g., over one or multiple landscapes).

In some instances, if the first identified pattern is associated with a first customer of the customers of the solution environment, the tracked data used for the classification can be historical tracked data for the first customer. If the first identified pattern is associated with at least one tenant as an instance of a first tenant type and at least one service as an instance of a first service type, the at least one tenant and at least one service that run on the solution environment are associated with a first client. In those cases, the tracked data used for the classification of the first identified pattern can be historical tracked data for other customers associated with tenant instances of the first tenant type and services of the first service type.

In some instances, based on executed algorithms to detect patterns and the pattern evaluation to classify the patterns and/or to obtain further evaluation through external assessment, rules can be defined or existing rules can be extended with new rules that can be used to classify automatically a pattern.

In some instances, rules to be executed on the snapshot data can be defined, where a rule can define a combination of a tenant type, a service type, and a landscape. In some cases, at least one of the rules can be executed over the snapshot data to match with at least one pattern from the identified patterns and to pre-classify the at least one pattern as one of the anomaly configuration type or the standard configuration type. Such classification can be performed before or in addition to using the tracked data for historically classified patterns to classify the pattern.

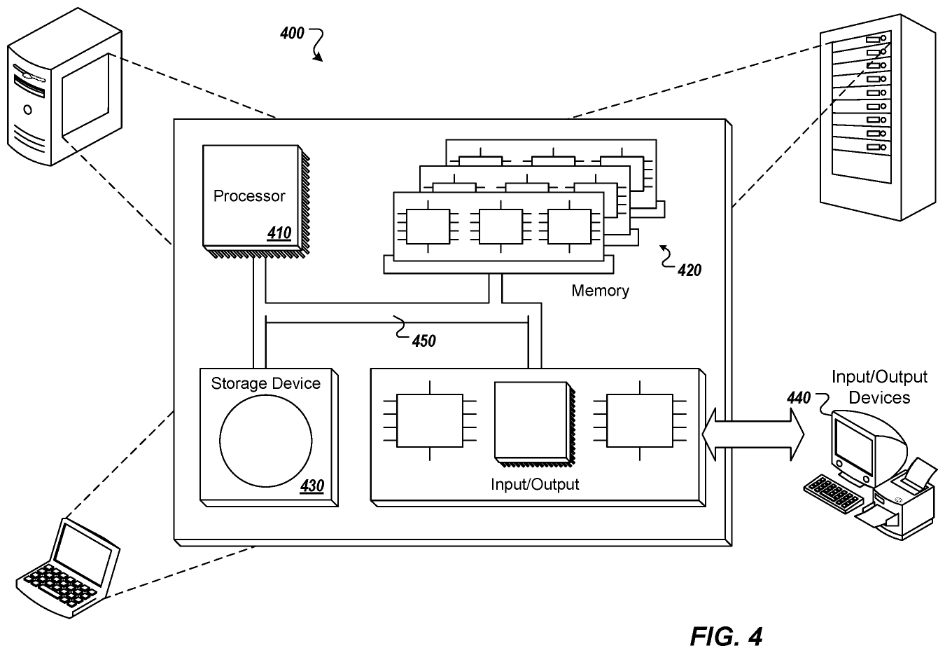

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

### Examples

Although the present application is defined in the attached claims, it should be understood that the present invention can also (alternatively) defined in accordance with the following examples:

Example 1: A computer-implemented method, the method comprising:
reading snapshot data representing configurations defined for customers of a solution environment, wherein the solution environment comprises a set of landscapes, wherein the snapshot data includes data for integrations between tenants and/or services of a set of customers;
evaluating the snapshot data according to detection algorithms to identify patterns in configurations in the solution environment based on historized snapshot data stored over time; and
classifying a first identified pattern of the patterns associated with a first configuration of the configurations in the solution environment as one of an anomaly configuration type or a standard configuration type, wherein the classifying is based on using tracked data for historically classified patterns associated with the solution environment.

Example 2. The method of claim 1, wherein evaluating the snapshot data comprises:
executing the detection algorithms;
providing the identified patterns in the configurations on a user interface to obtain user input for evaluation of the identified patters; and
storing the identified patterns together with assessment data generated based on the obtained user input as the tracked data used for the classifying of the identified pattern.

Example 3. The method of Example 2, wherein the assessment data comprises a classification type for each of the patterns, wherein the classification type comprises the anomaly configuration type and the standard configuration type.

Example 4. The method of any one of the preceding Examples, wherein classifying the first identified pattern as the anomaly configuration type comprises:
evaluating the snapshot data to identify that the first configuration matches a rule defined in a detection algorithm for anomalies, wherein the rule defines an anomaly combination of tenants and/or services for an integration defined for a first client, wherein the tenants and/or the services are associated with different landscapes of the set of landscapes of the solution environment.

Example 5. The method of any one of the preceding Examples, further comprising:
in response to classifying the first identified pattern as of the anomaly configuration type, providing the identified pattern for evaluation; and
in response to receiving input that the identified pattern is to be classified as of a standard configuration type, updating the classification for the first identified pattern.

Example 6. The method of any one of the preceding Examples, wherein the first identified pattern is associated with a first customer of the customers of the solution environment, and the tracked data used for the classification is historical tracked data for the first customer.

Example 7. The method of any one of the preceding Examples, wherein the first identified pattern is associated with at least one tenant as an instance of a first tenant type and at least one service as an instance of a first service type, wherein the at least one tenant and at least one service run on the solution environment and are associated with a first client, wherein the tracked data used for the classification of the first identified pattern is historical tracked data for other customers associated with tenant instances of the first tenant type and services of the first service type.

Example 8. The method of Example 5, further comprising:
providing data associated with the classified first pattern as of the anomaly configuration type to be used for evaluation and generation of instructions for executing a remediation procedure in the solution environment to modify configuration associated with the pattern to eliminate the anomaly.

Example 9. The method of any one of the preceding Examples, further comprising:
defining rules to be executed on the snapshot data, wherein each rule defines a combination of a tenant type, a service type, and a landscape; and
executing at least one of the rules over the snapshot data to match with at least one pattern from the identified patterns and to pre-classify the at least one pattern as one of the anomaly configuration type or the standard configuration type before using the tracked data for historically classified patterns to classify the pattern.

Example 10. The method of any one of the preceding Examples, wherein each configuration of the configurations is associated with a customer and defines at least one of i) a plurality of tenants of respective tenant types, ii) a tenant of a tenant type and a service of a service type, or ii) a plurality of services of respective service types, and an integration between tenants and/or services running on the solution environment.

Example 11. The method of any one of the preceding Examples, wherein the first identified pattern is classified as of the standard configuration type, when the first identified pattern meets a detection criterion defining a threshold number of customers associated with the same first identified pattern for each of respective configurations on the solution environment.

What is claimed is:

1. A computer-implemented method, the method comprising:
reading snapshot data representing configurations defined for customers of a solution environment, wherein the solution environment comprises a set of landscapes, wherein the snapshot data includes data for integrations between tenants and/or services of a set of customers;
evaluating the snapshot data according to detection algorithms to identify patterns in configurations in the solution environment based on historized snapshot data stored over time; and
classifying a first identified pattern of the patterns associated with a first configuration of the configurations in the solution environment as one of an anomaly configuration type or a standard configuration type, wherein the classifying is based on using tracked data for historically classified patterns associated with the solution environment.

2. The method of claim 1, wherein evaluating the snapshot data comprises:
executing the detection algorithms;
providing the identified patterns in the configurations on a user interface to obtain user input for evaluation of the identified patters; and
storing the identified patterns together with assessment data generated based on the obtained user input as the tracked data used for the classifying of the identified pattern.

3. The method of claim 2, wherein the assessment data comprises a classification type for each of the patterns, wherein the classification type comprises the anomaly configuration type and the standard configuration type.

4. The method of claim 1, wherein classifying the first identified pattern as the anomaly configuration type comprises:
evaluating the snapshot data to identify that the first configuration matches a rule defined in a detection algorithm for anomalies, wherein the rule defines an anomaly combination of tenants and/or services for an integration defined for a first client, wherein the tenants and/or the services are associated with different landscapes of the set of landscapes of the solution environment.

5. The method of claim 1, further comprising:
in response to classifying the first identified pattern as of the anomaly configuration type, providing the identified pattern for evaluation; and
in response to receiving input that the identified pattern is to be classified as of a standard configuration type, updating the classification for the first identified pattern.

6. The method of claim 1, wherein the first identified pattern is associated with a first customer of the customers of the solution environment, and the tracked data used for the classification is historical tracked data for the first customer.

7. The method of claim 1, wherein the first identified pattern is associated with at least one tenant as an instance of a first tenant type and at least one service as an instance of a first service type, wherein the at least one tenant and at least one service run on the solution environment and are associated with a first client, wherein the tracked data used for the classification of the first identified pattern is historical tracked data for other customers associated with tenant instances of the first tenant type and services of the first service type.

8. The method of claim 5, further comprising:
providing data associated with the classified first pattern as of the anomaly configuration type to be used for evaluation and generation of instructions for executing a remediation procedure in the solution environment to modify configuration associated with the pattern to eliminate the anomaly.

9. The method of claim 1, further comprising:
defining rules to be executed on the snapshot data, wherein each rule defines a combination of a tenant type, a service type, and a landscape; and
executing at least one of the rules over the snapshot data to match with at least one pattern from the identified patterns and to pre-classify the at least one pattern as one of the anomaly configuration type or the standard configuration type before using the tracked data for historically classified patterns to classify the pattern.

10. The method of claim 1, wherein each configuration of the configurations is associated with a customer and defines at least one of i) a plurality of tenants of respective tenant types, ii) a tenant of a tenant type and a service of a service type, or ii) a plurality of services of respective service types, and an integration between tenants and/or services running on the solution environment.

11. The method of claim 1, wherein the first identified pattern is classified as of the standard configuration type, when the first identified pattern meets a detection criterion defining a threshold number of customers associated with the same first identified pattern for each of respective configurations on the solution environment.

12. A non-transitory computer-readable storage medium coupled to one or more processors and having instructions stored thereon which, when executed by the one or more processors, cause the one or more processors to perform operations comprising:
reading snapshot data representing configurations defined for customers of a solution environment, wherein the solution environment comprises a set of landscapes, wherein the snapshot data includes data for integrations between tenants and/or services of a set of customers;
evaluating the snapshot data according to detection algorithms to identify patterns in configurations in the solution environment based on historized snapshot data stored over time; and
classifying a first identified pattern of the patterns associated with a first configuration of the configurations in the solution environment as one of an anomaly configuration type or a standard configuration type, wherein the classifying is based on using tracked data for historically classified patterns associated with the solution environment.

13. The non-transitory computer-readable storage medium of claim 12, wherein evaluating the snapshot data comprises:
executing the detection algorithms;
providing the identified patterns in the configurations on a user interface to obtain user input for evaluation of the identified patters; and
storing the identified patterns together with assessment data generated based on the obtained user input as the tracked data used for the classifying of the identified pattern.

14. The non-transitory computer-readable storage medium of claim 13, wherein the assessment data comprises a classification type for each of the patterns, wherein the classification type comprises the anomaly configuration type and the standard configuration type.

15. The non-transitory computer-readable storage medium of claim 12, wherein classifying the first identified pattern as the anomaly configuration type comprises:
evaluating the snapshot data to identify that the first configuration matches a rule defined in a detection algorithm for anomalies, wherein the rule defines an anomaly combination of tenants and/or services for an integration defined for a first client, wherein the tenants and/or the services are associated with different landscapes of the set of landscapes of the solution environment.

16. The non-transitory computer-readable storage medium of claim 12, further storing instructions, which, when executed by the one or more processors, cause the one or more processors to perform operations comprising:
in response to classifying the first identified pattern as of the anomaly configuration type, providing the identified pattern for evaluation; and
in response to receiving input that the identified pattern is to be classified as of a standard configuration type, updating the classification for the first identified pattern.

17. A system, comprising:
a computing device; and
a computer-readable storage device coupled to the computing device and having instructions stored thereon which, when executed by the computing device, cause the computing device to perform operations comprising:
reading snapshot data representing configurations defined for customers of a solution environment, wherein the solution environment comprises a set of landscapes, wherein the snapshot data includes data for integrations between tenants and/or services of a set of customers;
evaluating the snapshot data according to detection algorithms to identify patterns in configurations in the solution environment based on historized snapshot data stored over time; and
classifying a first identified pattern of the patterns associated with a first configuration of the configurations in the solution environment as one of an anomaly configuration type or a standard configuration type, wherein the classifying is based on using tracked data for historically classified patterns associated with the solution environment.

18. The system of claim 17, wherein evaluating the snapshot data comprises:
executing the detection algorithms;
providing the identified patterns in the configurations on a user interface to obtain user input for evaluation of the identified patters; and
storing the identified patterns together with assessment data generated based on the obtained user input as the tracked data used for the classifying of the identified pattern.

19. The system of claim 18, wherein the assessment data comprises a classification type for each of the patterns, wherein the classification type comprises the anomaly configuration type and the standard configuration type.

20. The system of claim 17, wherein classifying the first identified pattern as the anomaly configuration type comprises:
evaluating the snapshot data to identify that the first configuration matches a rule defined in a detection algorithm for anomalies, wherein the rule defines an anomaly combination of tenants and/or services for an integration defined for a first client, wherein the tenants and/or the services are associated with different landscapes of the set of landscapes of the solution environment.
